(19) United States
(12) Patent Application Publication
(10) Pub. No.: US 2026/0025732 A1
(43) Pub. Date: Jan. 22, 2026

(54) WIRELESS COMMUNICATION SYSTEM, COMMUNICATION PATH CONTROL DEVICE, COMMUNICATION PATH CONTROL METHOD, AND COMMUNICATION PATH CONTROL PROGRAM

(71) Applicants: NIPPON TELEGRAPH AND TELEPHONE CORPORATION, Tokyo (JP); NTT DOCOMO, INC., Tokyo (JP)

(72) Inventors: Munehiro MATSUI, Musashino-shi, Tokyo (JP); Fumihiro YAMASHITA, Musashino-shi, Tokyo (JP); Junichi ABE, Musashino-shi, Tokyo (JP); Hisayoshi KANO, Musashino-shi, Tokyo (JP); Atsushi MINOKUCHI, Tokyo (JP); Kenta YAMAUCHI, Tokyo (JP); Yoshihisa KISHIYAMA, Tokyo (JP); Hinata KOHARA, Tokyo (JP); Yuto MUROKI, Tokyo (JP); Yuki HOKAZONO, Tokyo (JP)

(73) Assignees: NIPPON TELEGRAPH AND TELEPHONE CORPORATION, Tokyo (JP); NTT DOCOMO, INC., Tokyo (JP)

(21) Appl. No.: 18/998,520

(22) PCT Filed: Jul. 28, 2022
(86) PCT No.: PCT/JP2022/029168

§ 371 Date: Jan. 27, 2025

(51) Int. Cl. H04W 40/12; H04W 84/06

(52) U.S. Cl. CPC H04W 40/12; H04W 84/06

(57) ABSTRACT

A plurality of communication stations such as aerial vehicles, LEO satellites and GEO satellites transfer packets by mutually establishing links. A UE connects to the aerial vehicle providing a service area and transmits and receives packets to and from a data network. A route control device collects information on the required QoS corresponding to the service type of the UE, predicts the communication qualities of the links between the communication stations, and determines a communication path based on the communication qualities so that the required QoS is satisfied between the aerial vehicle and the data network. The communication stations included in the communication path receive distribution of a routing table including the transfer destination information of the traffic and transfer the packet according to the information.

### TECHNICAL FIELD

This disclosure relates to a wireless communication system, a communication path control device, a communication path control method, and communication path control program, and particularly to a wireless communication system, a communication path control device, a communication path control method, and a communication path control program that are suitable for enabling efficient wireless communication using a non-terrestrial network.

### BACKGROUND ART

In recent years, mobile communication systems have developed, and mobile services can be enjoyed on most of the ground. Super coverage is one of the requirements for 5th generation or 6th generation mobile communication systems that are expected to be commercialized in the future. Ultra-coverage means expanding services to areas where the cost of laying existing base stations is expensive, such as in mountainous areas, at sea, and in the air, and where it is difficult to lay base stations. In addition, it is also necessary to strengthen the resilience of the country to natural disasters, and there is a desire for the emergence of a communication system that is resistant to ground disasters.

To meet the above requirements, non-terrestrial networks (NTNs) using satellites, unmanned aerial vehicles (UAVs), high-altitude pseudo-satellites (HAPS), drones, etc. are in the spotlight. An example of an NTN composed of a HAPS network is shown in Fig.

The unmanned aerial vehicle (hereinafter referred to as the aerial vehicle) 10 has the function of irradiating a beam against the ground to form a mobile service area. A ground-based wireless terminal (hereinafter, UE: User Equipment) 14 that exists in the service area 12 is connected to the HAPS aerial vehicle 10 and is connected to the ground base station 16 via the aerial vehicle 10. The aerial vehicle 10 is equipped with a signal relay function. The packet sent by the UE 14 is sent to the data network 20 via the aerial vehicle 10, the ground base station 16, and the mobile network 18. Packets addressed from the data network 20 to the UE 14 are similarly relayed.

In the future, a multi-layer satellite network consisting of multiple satellites and HAPS networks may be considered. An example of an NTN consisting of a geostationary orbiting satellite (GEO satellite), a low-Earth orbiting satellite (LEO satellite), and a HAPS network is shown in FIG. 2.

In the NTN shown in FIG. 2, satellites 22, 24 and aerial vehicles 10 belonging to each network connect each other to form a network. Satellites 22, 24 and the aerial vehicle 10 have a routing function, and traffic sent by the UE 14 is transferred by them and sent to the Internet network.

In the future multi-layer satellite network shown in FIG. 2, traffic generated between the UE 14 and the Internet is routed as nodes to each satellite 22 and 24 in the GEO satellite or LEO satellite network and to the aerial vehicle 10 in the HAPS network. Each of these networks has different characteristics. The characteristics of the individual networks are shown in Table 1.

TABLE 1

| | | |
|---|---|---|
| Altitude of Aerial vehicle | 20 | km |
| Altitude of LEO Satellite | 500 | km |
| Altitude of GEO Satellite | 36,000 | km |

As shown in Table 1, the altitude of the aerial vehicle 10 and the satellite 22 and 24 are different, and the signal propagation delay varies greatly depending on which route it passes. Since GEO satellite 24 is located at an altitude of about 36,000 km, it will take at least 120 ms for the signal transmitted by UE 14 to arrive at satellite 24, depending on the elevation angle. On the other hand, since the aerial vehicle 10 of the HAPS network is located at an altitude of about 20 km, the time it takes for the signal transmitted from the UE 14 to arrive at the aerial vehicle 10 is about 0.07 ms, which is a lower latency than when passing through the GEO satellite 24.

Further, since the communication device mounted on the satellite 22, 24 and the aerial vehicle 10 varies depending on constraints such as load weight and power consumption, the band of the inter-node link of the satellite 22, 24 and the aerial vehicle 10 may be different. In view of this, the following Non-Patent Document 1 proposes a routing method that considers the propagation delay time due to the distance between the satellite/aerial vehicle nodes, as well as the band of the link between the satellite/aerial vehicle nodes.

On the other hand, the UE 14 of the mobile communication system uses a wide variety of applications such as voice calls, video transmission, and IoT communication using sensors. And the required quality of service (QoS) varies depending on the application, such as the required transmission speed and allowed latency. For example, low latency is required for voice calls, and a certain high transmission speed is required for video transmission, depending on the image quality.

### CITATION LIST

### Non Patent Literature

Non Patent Literature 1: Development of extreme coverage communication system extended by Non-Terrestrial Network (NTN)—A proposal on a routing algorithm that determines the optimal data transfer route by calculating the congestion degree and delay time—Hisayoshi KANO, Munehiro MATSUI, Jun-ichi ABE, Yuki HOKAZONO, Hinata KOHARA, Yoshihisa KISIHAYMA1 and Fumihiro YAMASHITA1, The Institute of Electronics, Information and Communication Engineers Satellite Communication Study Group, SAT2021-56, p 19-24, February 2022

### SUMMARY OF INVENTION

### Technical Problem

To satisfy the required QoS in various applications such as the above in the UE 14, it is necessary to control the required transmission rate, delay time, etc. in an end to end (E2E) from the UE 14 to the data network.

In a multi-layer satellite network consisting of a plurality of satellite networks, traffic may flow in various routes between the satellites 22 and 24 connected by the UE 14 and the mobile network 18 on the ground. Then, since the propagation delay time and the band are different in the link between the nodes such as the satellite 22, 24 and the aerial vehicle 10, it is necessary to set the route suitable for the required QoS. In addition, when a transmission rate of a certain or higher is required as the required QoS, it is necessary to secure a bandwidth that meets the requirements in the link connecting the satellite 22 and 24 and the aerial vehicle 10 included in the set route.

In the routing technology described above in Non-Patent Document 1, the required QoS of the application used by the UE 14 is not taken into account. In addition, this technology performs routing control to select the optimal link for each link, and does not calculate the route overlooking E2E. As a result, the technology described in Non-Patent Document 1 cannot necessarily satisfy the QoS required by E2E.

The present disclosure is made in view of the above issues, and the first purpose is to provide a wireless communication system that sets a route that satisfies the required QoS of each application used by a wireless terminal in E2E in a non-terrestrial network.

In addition, the second purpose of the present disclosure is to provide a communication path control device that sets a route that satisfies the required QoS of each application used in a wireless terminal in E2E in a non-terrestrial network.

In addition, the third purpose of the present disclosure is to provide a communication path control method for setting a route that satisfies the required QoS of each application used by a wireless terminal in E2E in a non-terrestrial network.

In addition, the present disclosure has a fourth purpose of providing a communication path control program for setting a route that satisfies the required QoS of each application used by a wireless terminal in E2E in a non-terrestrial network.

### Means to Solve Problems

To achieve the above objects, a first aspect is desirably a wireless communication system in which a plurality of communication stations configure a network for transferring packets by mutually establishing links, the plurality of communication stations including a connection communication station for providing a service area to a wireless terminal, and the wireless terminal connecting to the connection communication station and transmitting and receiving packets to and from a data network, the wireless communication system comprising a control station configured to perform:

QoS collection processing of collecting information on required QoS corresponding to a service type of the wireless terminal;
quality prediction processing of predicting communication quality in a link between the plurality of communication stations;
path determination processing of determining a communication path based on the communication quality so that the required QoS is satisfied between the connection communication station and the data network; and
processing of distributing a routing table including transfer destination information of traffic to at least a communication station included in the communication path, wherein
said communication station included in the communication path is configured to transfer a packet between the wireless terminal and the data network in accordance with the routing table.

In addition, a second aspect is desirably a communication path control device that controls communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control device is configured to perform:
QoS collection processing of collecting information on required QoS corresponding to a service type of the wireless terminal;
quality prediction processing of predicting communication quality in a link between the plurality of communication stations;
path determination processing of determining a communication path based on the communication quality so that the required QoS is satisfied between the connection communication station and the data network; and
processing of distributing a routing table including transfer destination information of traffic to at least a communication station included in the communication path.

In addition, a third aspect is desirably a communication path control method for controlling communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control method including:
QoS collection step of collecting information on required QoS corresponding to a service type of the wireless terminal;
quality prediction step of predicting communication quality in a link between the plurality of communication stations;
path determination step of determining a communication path based on the communication quality so that the required QoS is satisfied between the connection communication station and the data network; and
step of distributing a routing table including transfer destination information of traffic to at least a communication station included in the communication path.

In addition, a fourth aspect is desirably a communication path control program for controlling communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control program includes a program that causes a processor unit to execute:
QoS collection processing of collecting information on required QoS corresponding to a service type of the wireless terminal;
quality prediction processing of predicting communication quality in a link between the plurality of communication stations;
path determination processing of determining a communication path based on the communication quality so that the required QoS is satisfied between the connection communication station and the data network; and
processing of distributing a routing table including transfer destination information of traffic to at least a communication station included in the communication path.

### Advantageous Effects of Invention

According to the first to fourth aspects, it is possible to set a route that satisfies the required QoS in E2E for each application used by the wireless terminal in a non-terrestrial network.

### BRIEF DESCRIPTION OF DRAWINGS

FIG. 1 is a diagram illustrating an example of an NTN composed of a HAPS network;

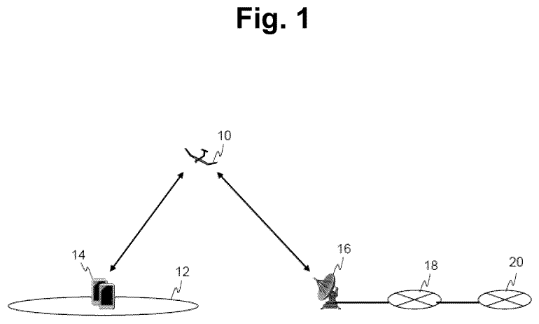

FIG. 2 is a diagram illustrating an example of an NTN consisting of a geostationary orbit satellite, a low-earth orbit satellite, and a HAPS network;

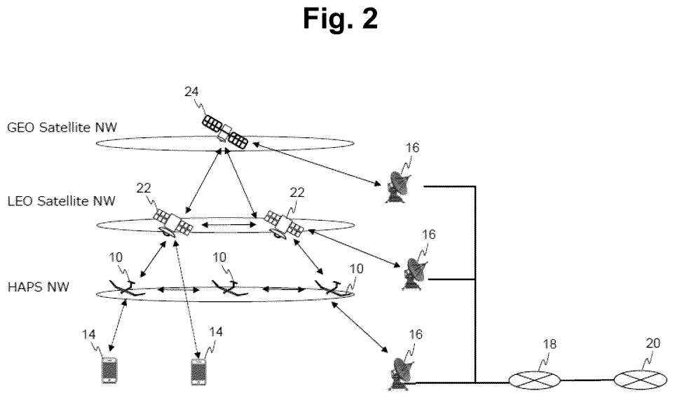

FIG. 3 is a diagram illustrating a configuration of the wireless communication system of a first embodiment of the present disclosure;

FIG. 4 is a flowchart for explaining the flow of processing performed in the wireless communication system shown in FIG. 3;

FIG. 5 is a diagram for explaining an example of operation of the wireless communication system of the first embodiment of the present disclosure;

FIG. 6 is a flowchart for explaining the operation of the wireless communication system of a third embodiment of the present disclosure; and

FIG. 7 is a diagram for explaining an example of operation of the wireless communication system of a sixth embodiment of the present disclosure.

### DESCRIPTION OF EMBODIMENTS

### First Embodiment

### [Configuration of First Embodiment]

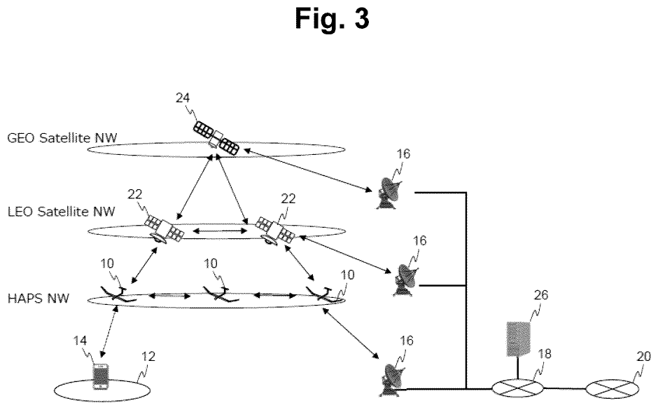

FIG. 3 illustrates a wireless communication system in first embodiment of the present disclosure. The wireless communication system of the present embodiment is composed of a GEO satellite 24, a LEO satellite 22, a aerial vehicle 10, a UE 14, a ground base station 16, a mobile core network 18, and a route control device 26. The GEO satellite 24, the LEO satellite 22, and the aerial vehicle 10 form a service area 12 relative to the ground as part of the GEO satellite network, the LEO satellite network, and the HAPS network, respectively.

The aerial vehicle 10 is equipped with a base station function, and it is possible to accommodate the UE 14 in the service area 12 and make it connected to the network. In addition, the satellites 22, 24 and the aerial vehicle 10 are equipped with a link function and a routing function that relays signals. The satellites 22, 24 and the aerial vehicle 10 establish a network with connection links each other between them and relay the transmission and reception signals between the UE 14 and the mobile core network 18 in the service area 12.

The UE 14 corresponds to a mobile communication system and connects to the data network 20 through the HAPS network configured by the aerial vehicle 10 to execute various communication applications. The ground base station 16 transmits and receives signals between the satellites 22, 24 and the aerial vehicle 10 and the mobile core network 18 on the ground.

The mobile core network 18 performs mobility control such as management of the connected UE 14 and handover, transmission and reception session control, etc. The mobile core network 18 further transfers packets between the UE 14 and the data network 20.

The system of the present embodiment includes a route control device 26 as part of the mobile core network 18. The route control device 26 derives effective transmission rate, etc. from information such as the propagation delay time according to the distance of each link and the band used by each link. Then, based on the derived results, the route controller 26 selects a route between the satellite 22, 24 and the aerial vehicle 10 to which the UE 14 is connected and the mobile core network 18 for each session, and distributes a routing table for route setting to the satellite 22, 24 and the aerial vehicle 10.

The route control device 26 may be configured by combining dedicated hardware. Alternatively, the route control device 26 may be configured by hardware including a processor unit and a memory device. In the latter case, a dedicated communication path control program may be stored in the memory device, and the program may be executed by the processor unit to realize the desired function.

### [Operation of First Embodiment]

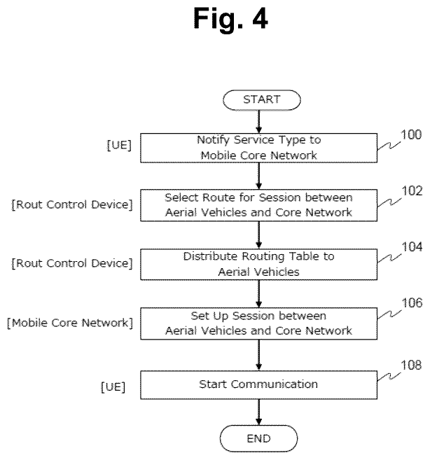

FIG. 4 is a flowchart for explaining a flow of processing performed in the system of the present embodiment. As shown in FIG. 4, the service type of the application to be used is first notified from the UE 14 connected to the network toward the mobile core network 18 in the system of the present embodiment (step 100).

Next, a route to be used is selected in the route control device 26 included in the mobile core network 18 (step 102). Specifically, based on the service type of the application and the link information between the satellites 22, 24 and the aerial vehicle 10, the route for the session between the satellites 22, 24 and/or the aerial vehicle 10 connected by the UE 14 and the mobile core network 18 is calculated or selected.

Next, a table for routing is distributed from the route control device 26 to the satellite 22, 24 and the aerial vehicle 10 so that the route selected by the above processing is used (step 104).

After completing the above process, the mobile core network 18 sets up a session between the satellite 22, 24 and/or the aerial vehicle 10 to which the UE 14 is connected and the mobile core network 18 (step 106). At this time, the mobile core network 18 issues a transmission control command to the satellite 22, 24 and/or the aerial vehicle 10 included in the route of the set session to satisfy the required transmission speed required by QoS. The command of the transmission control more specifically includes a command for the satellite 22, 24 and/or the aerial vehicle 10 to require for the bandwidth guarantee necessary to satisfy the QoS. When the satellite 22, 24 and the aerial vehicle 10 receive the above command, they perform transmission control such as transmission scheduling and priority transmission so that the bandwidth guarantee is satisfied.

Finally, communication is started by the UE 14 (step 108).

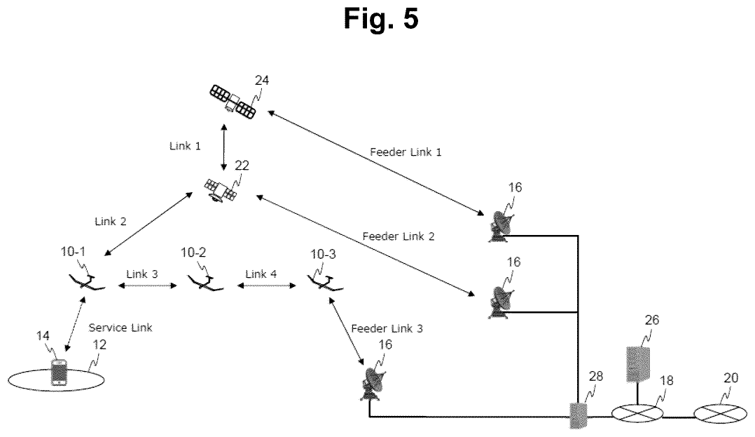

FIG. 5 illustrates an example of a network assumed to illustrate the operation of the system of the present embodiment. As shown in FIG. 5, the GEO satellite network and the LEO satellite network shall consist of one GEO satellite 24 and one LEO satellite 22, respectively. On the other hand, the HAPS network shall include three aerial vehicles 10. In this network, IP-based packet routing is performed. It is assumed that the IP address is assigned to the satellite 22, 24 and the aerial vehicle 10 and the router 28. Table 2 shows an example of the IP address assigned to each element.

TABLE 2

| | |
|---|---|
| GEO Satellite | 192.168.0.1 |
| LEO Satellite | 192.168.1.1 |
| Aerial vehicle 1 | 192.168.2.1 |
| Aerial vehicle 2 | 192.168.3.1 |
| Aerial vehicle 3 | 192.168.4.1 |
| Router | 192.168.5.1 |
| Mobile Core Network | 192.168.6.1 |

In the example shown in FIG. 5, there are four links between the satellite 22, 24 and the aerial vehicle 10. The band and propagation delay of each link depend on the performance of the communication device mounted on the satellite 22, 24 and the aerial vehicle 10 and the distance of the link, and can be identified based on known information. Table 3 shows an example of the band and propagation delay of each link.

TABLE 3

| | Link Band | Propagation | |
|---|---|---|---|
| | [Mbit/s] | Delay [ms] | Others |
| Link 1 | 100 | 118 | High jitter |
| Link 2 | 500 | 1.6 | High jitter |
| Link 3 | 1,000 | 0.3 | Low jitter |
| Link 4 | 1,000 | 0.3 | Low jitter |

Note that the LEO satellite 22 moves relative to the the GEO satellite 24 and aerial vehicle 10 that make up the HAPS. As a result, a plurality of LEO satellites 22 in orbit are successively switched and used to communicate. As a result, at the link 1 connecting the GEO satellite 24 and the LEO satellite 22, and at the link 2 connecting the aerial vehicle 10 and the LEO satellite 22, the disconnection and connection are repeated, causing frequent instantaneous interruptions, and high jitter occurs as shown in Table 3.

The aerial vehicle 10 and the satellites 22 and 24 each have one ground base station and are connected to the mobile core network 18. The band and propagation delay in the link between the UE 14 and the aerial vehicle 10 (service link) and the link between the satellite 22, 24 and the aerial vehicle 10 and the ground base station 16 (feeder link) are shown in Table 4.

TABLE 4

| | Link Band | Propagation |
|---|---|---|
| | [Mbit/s] | Delay [ms] |
| Service Link | 2,000 | 0.07 |
| Feeder Link 1 | 200 | 120 |
| Feeder Link 2 | 1,000 | 1.7 |
| Feeder Link 3 | 2,000 | 0.07 |

The aerial vehicle 10 forms a service area 12 with a beam on the ground surface. The UE 14 in the service area 12 then connects to the aerial vehicle 10 and communicates with the data network 20 via various satellite networks, HAPS networks, and mobile core networks 18. Table 5 shows the service types expected to be used by the UE 14 and the required QoS corresponding to each service type. Note that, in the present embodiment, an example of a case in which the UE 14 uses the service type 2 will be explained.

TABLE 5

| | | Required Qos | | | | |
|---|---|---|---|---|---|---|
| Service | Description of | Transmission | | Allowable | | |
| Type | Service Type | speed | | delay time | | Others |
| 1 | High-speed | 100 | Mbit/s | 200 | ms | |
| | High-capacity | | | | | |
| | Service | | | | | |
| 2 | Ultra-reliable | 30 | Mbit/s | 50 | ms | Low |
| | Low-latency | | | | | Jitter |
| | Service | | | | | |
| 3 | Massive IoT | 1 | Mbit/s | 10 | s | |

Service

In FIG. 5, the UE 14 belonging to the service area 12 provided by the first aerial vehicle 10-1 connects to the aerial vehicle 10-1 when starting communication. Thereafter, information or the likes of the UE 14 is transmitted to the mobile core network 18 via the link 3 and the link 4, and a session is arranged between the UE 14 and the mobile core network 18 after the registration (attachment) process, etc., of the UE 14 is performed.

At this stage, the route control device 26 calculates a route suitable for each session. Specifically, the service type is first notified from the UE 14 to the mobile core network 18. Next, the route control device 26 in the mobile core network that receives the notification of the service type calculates or selects a route that satisfies the required QoS for each service type for the session. For the UE 14 of service type 2, the route via the service link->link 3->link 4->feeder link 3 is suitable to satisfy the required QoS.

The reason is, in the above route, all link bands exceed the required QoS of service type 2, the transmission rate of 30 Mbit/s. In addition, the total propagation delay of this route is 0.07+0.3+0.3+0.07=0.74 (see Table 3 and Table 4), which satisfies the propagation delay of service type 2. Further, since the links included in this route are all low jitter (see Table 3), they meet the QoS of service type 2 in terms of latency. Note that other routes are not suitable for service type 2 routes because they cannot completely satisfy jitter requirements.

For the above reasons, here, a route via the service link->link 3->link 4->feeder link 3 is selected for the session. “1” is assigned as the ID of this session, and a routing table is distributed to the satellite 22, 24 and the aerial vehicle 10 on the route. Table 6 shows an example of the routing table when traffic flows from the UE 14 to the mobile core network 18.

TABLE 6

| | | |
|---|---|---|
| Destination | Session ID | Next Hop |

Routing table of aerial vehicle 10-1

| | | |
|---|---|---|
| 192.168.6.1 | 1 | 192.168.3.1 |
| | | (Aerial vehicle 10-2) |

Routing table of aerial vehicle 10-2

| | | |
|---|---|---|
| 192.168.6.1 | 1 | 192.168.4.1 |
| | | (Aerial vehicle 10-3) |

Routing table of aerial vehicle 10-3

| | | |
|---|---|---|
| 192.168.6.1 | 1 | 192.168.5.1 (Router 28) |

Routing table of Router 28

| | | |
|---|---|---|
| 192.168.6.1 | 1 | 192.168.6.1 |

After the above table distribution is complete, the UE 14 starts to communicate. The traffic flowing from the UE 14 to the mobile core network 18 includes the IP address and the session ID of the destination, the mobile core network 18. Furthermore, each of the aerial vehicle 10, the satellite 22, 24 and the router 28 refers to the session ID in addition to the IP address of the destination and flows traffic to the next hop. This makes it possible to transfer traffic on the route specified for each session.

Similarly, for traffic flowing from the mobile core network 18 to the UE 14, a table for routing the reverse route with the aerial vehicle 10-1 as the destination is distributed, as shown in Table 7. This makes it possible to transfer traffic on the route specified for each session.

TABLE 7

| | | |
|---|---|---|
| Destination | Session ID | Next Hop |

Routing table of aerial vehicle 10-1

| | | |
|---|---|---|
| 192.168.2.1 | 1 | Within Cover Area |

Routing table of aerial vehicle 10-2

| | | |
|---|---|---|
| 192.168.2.1 | 1 | 192.168.2.1 |
| | | (Aerial vehicle 10-1) |

Routing table of aerial vehicle 10-3

| | | |
|---|---|---|
| 192.168.2.1 | 1 | 192.168.3.1 |
| | | (Aerial vehicle 10-2) |

Routing table of Router 28

| | | |
|---|---|---|
| 192.168.2.1 | 1 | 192.168.4.1 |
| | | (Aerial vehicle 10-3) |

Afterwards, the satellite 22, 24 and the aerial vehicle 10 on the route issue commands to perform transmission control and band control that meet the required transmission speed for each session. As described above, in the example of the present embodiment, a route using the link 3, the link 4, and the feeder link 3 (the “aerial vehicle route”) is selected for the UE 14 of the service type 2 via the aerial vehicle 10-1 to 10-3. In that case, the aerial vehicles 10-1, 10-2, and 10-3 that exist on the route perform transmission control such as transmission scheduling and priority transmission for packets with the session ID attached so as to meet the required transmission speed of 30 Mbit/s. When these processes are complete, the UE 14 starts to communicate.

As explained above, the wireless communication system of the present embodiment selects an appropriate route according to the required QoS of the UE 14 in consideration of the band, propagation delay, and jitter of each link. Therefore, according to the system of the present embodiment, the required QoS of the UE 14 can be appropriately satisfied while utilizing the NTN.

Note that, in the present embodiment, it is assumed that the UE 14 is of service type 2, but the following two routes can be used for the UE 14 of service type 1. Each of these routes will be selected for the session to meet the required QoS of UE 14.
1. The above “aerial vehicle route” via aerial vehicle 10-1 to 10-3.
2. A route using Link 2 and Feeder Link 2 via LEO satellite 22 (herein after referred to “LEO Route”).

For the UE 14 of service type 3, the following third route may be used in addition to the above-mentioned aerial vehicle route and LEO route.
3. A route using Link 2, Link 1 and Feeder Link 1 via GEO Satellite 24 (hereinafter referred to “GEO Route”).

Therefore, when the UE 14 uses the service type 3, one of the routes from 1 to 3 above is selected for the session.

It should be noted that, in the present embodiment, a route for the session is calculated or selected based on the band, propagation delay, and jitter of the link between the satellite 22, 24, and the aerial vehicle 10, but the present disclosure is not limited thereto. For example, routes may be selected by taking into account the time required for relay processing on the aerial vehicle 10 and the satellite 22 and 24. Furthermore, routes may be selected using measures such as the error rate and packet loss rate of each link.

Further, in the present embodiment, an example of having a base station function mounted on the aerial vehicle 10 is shown, but the present disclosure is not limited thereto. For example, even if the base station function is mounted on the satellite 22 and 24 and the UE 14 is connected to the satellite 22 and 24, the same processing as in the case of the present embodiment is possible.

In addition, the installation location of the base station function is not limited to the satellite 22, 24 or the aerial vehicle 10. The technology according to the present disclosure can also be applied to, for example, installing a base station function on the ground and using a satellite network and/or a HAPS network as a backhaul line. In this case, the same processing as in the present embodiment is possible if a link function and a routing function for relaying a signal are implemented in the satellite 22, 24 or the aerial vehicle 10.

Further, by storing past determined communication path results in the database, when a communication path is selected for a newly connected wireless terminal, the communication path may be calculated by referring to the above database. Specifically, communication routes assigned to one or more required QoS similar to the required QoS of the new wireless terminal may be read from the database to narrow down the candidate route. With such a method, the time for route selection can be reduced.

In addition, in the present embodiment, the transmission speed, available band, propagation delay time, frequency of disconnection, etc. of each link are focused on as a basis for route selection. However, these are examples of information that can be used as a basis for route selection, and the present disclosure is not limited thereto. For example, the permitted connection time for each link (link connection time) and the stability of each link may be used as the basis for route selection.

### Second Embodiment

The wireless communication system of the present embodiment can be realized by the configuration shown in FIG. 3 or FIG. 5 as in the case of the first embodiment described above. The system of the first embodiment selects a communication route based on the link band and the propagation delay. The wireless communication system of the present embodiment is characterized by the fact that the number of sessions in which each link is used, the amount of traffic flowing to each link, etc. are used as the basis for route selection. More specifically, the system of the present embodiment is characterized by calculating the excess band and the effective transmission rate for each link based on the number of sessions and the amount of traffic described above, and reflecting the result in route selection.

Hereinafter, as in the case of the first embodiment, the description will proceed using the network shown in FIG. 5. As stated above, the network shown in FIG. 5 can use three routes with GEO satellite 24, LEO satellite 22, and aerial vehicle 10-1-10-3 as the top transit points, respectively.

Table 8 below shows an example of the number of sessions accommodated by each route by service type. Note that the “-” in the “Service Type 1” and “Service Type 2” columns at the top of Table 8 indicates that routes through the GEO satellite 24 do not accept those service types that require high capacity and low latency. Table 8 second stage also similarly shows that routes via LEO satellites 22 do not accept “Service Type 2”.

TABLE 8

| | Service | Service | Service |
|---|---|---|---|
| | Type 1 | Type 2 | Type 3 |
| GEO Route | — | — | 100 |
| LEO Route | 3 | — | |
| Aerial vehicle Route | 0 | 10 | 0 |

Each link is given one or more usable bands, previously. Then, excess bandwidth of each link accommodating sessions decreases as the number of sessions accommodating increases. Table 9 illustrates the usage bandwidth of each link shown in FIG. 5 and the excess bandwidth when they accommodate the number of sessions shown in Table 8 above.

TABLE 9

| | Using Bandwidth | Excess Bandwidth |
|---|---|---|
| Link 1 | 100 | 0 |
| Link 2 | 400 | 100 |
| Link 3 | 300 | 700 |
| Link 4 | 300 | 700 |
| Feeder Link 1 | 100 | 100 |
| Feeder Link 2 | 400 | 600 |
| Feeder Link 3 | 300 | 1,700 |

Assuming that the UE 14 of service type 3 has newly connected to the network shown in FIG. 5. Since Service Type 3 is a “massive IoT service”, the GEO route, LEO route, and aerial vehicle route are all appropriate in terms of propagation delay. However, the link 1 included in the GEO route has zero excess band in Table 9. In that case, the GEO route is judged to be inappropriate as a new UE 14 route because the effective transmission rate is also zero.

For the above reasons, the route control device 26 of the present embodiment selects either the LEO route using the link 2 and the feeder link 2, or the aerial vehicle route using the link 3, the link 4 and the feeder link 3.

It should be noted that, in the above embodiment, the excess bandwidth of each link is calculated from the number of sessions accommodated in each route, but the present disclosure is not limited thereto. For example, the amount of traffic flowing through each route may be detected, and the excess bandwidth or the effective transmission rate of each link may be calculated from the amount of traffic.

### Third Embodiment

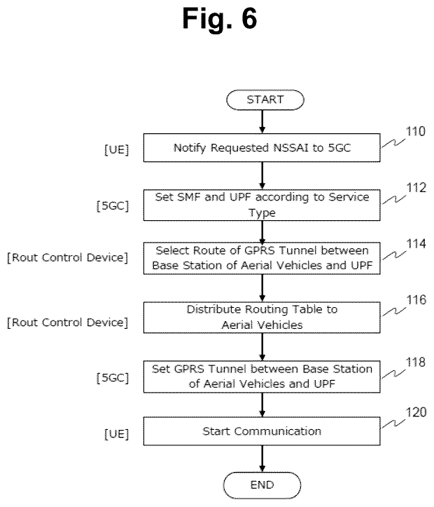

A wireless communication system of a third embodiment of the present disclosure will now be described with reference to FIG. 6 together with FIGS. 3 and 5. Here, an example of operation when the technology according to the present disclosure is applied to a Fifth-generation (5G) communication system is shown. The wireless communication system of the present embodiment can be realized by the configuration shown in FIG. 3 or FIG. 5 as in the case of the first embodiment described above. However, the mobile core network 18 shall be a 5G compatible mobile core network (5GC). Hereinafter, for convenience, the 5GC used in the present embodiment will be explained with a reference number 18 as in the case of the first and second embodiments.

In the 5G communication standard, a GPRS (General Packet Radio Service) tunnel using GTP (GPRS Tunneling Protocol) is set up between the 5G base station (gNB: next Generation Node B) and 5GC 18. In the present embodiment, the aerial vehicle 10 is equipped with a gNB function as a base station function, and a GPRS tunnel is formed between the aerial vehicle 10 and the 5GC.

FIG. 6 shows a flowchart of operations implemented in the wireless communication system of the present embodiment. As shown in FIG. 6, the UE 14 sends a Requested NSSAI (Network Slicing Selection Assistance information) including information on the service type to the gNB mounted on the aerial vehicle 10 when connecting to the 5GC 18. The gNB transmits the received information to the Access and Mobility Management Function (AMF) in the 5GC 18 (step 110).

In the 5GC 18, the AMF sets the Session Management Function (SMF) and the User Plane Function (UPF) according to the service type (step 112).

Next, in the route control device 26 of the 5GC 18, a route for the GPRS tunnel between the satellite 22 and 24 connected by the UE 14 or the aerial vehicle 10 and the UPF provided by the 5GC 18 is calculated and selected (step 114). The selection of the route is based on the link information, etc., between the satellite 22, 24 and the aerial vehicle 10 as in the case of the first and second embodiments.

The route control device 26 then distributes a table for routing to the satellite 22, 24 and the aerial vehicle 10 so that the route selected in the above process is used (step 116). This process is substantially the same as the process described in step 104 in the first embodiment (see Table 6 and Table 7).

The 5GC 18 then sets up a GPRS tunnel between the satellite 22, 24 and the aerial vehicle 10 and the 5GC 18 to which the UE 14 is connected (step 118).

After the above processing is complete, communication is started by the UE 14 (step 120).

An example of operation of the wireless communication system of the present embodiment will be explained below. The assumed network configuration is the same as in FIG. 5. As in the case of the first and second embodiments, packet routing on an IP basis is also performed in the system of the present embodiment. The aerial vehicle 10, the satellite 22, 24 and the router 28 etc. are assigned an IP address similar to that described in reference to Table 2.

In addition, the band and propagation delay for the link between the satellites 22, 24 and the aerial vehicle 10 and the feeder link between them and the ground base station 16 shall be the same as in Table 3 and Table 4. For UE 14, the same service type and required QoS as those shown in Table 5 are assumed. Hereinafter, an example of operation will be explained while assuming that the UE 14 is a service type 2 with reference to FIG. 5.

The UE 14 located in the service area 12 of the aerial vehicle 10-1 makes connection with the aerial vehicle 10-1 when starting communication. At this stage, first, it is connected to the 5GC 18 via link 3=>link 4=>feeder link 3 which is set as the default route of the control signal. In the 5GC 18, a registration (attachment) process of the UE 14 is performed. The UE 14 sends to the 5GC 18 a Requested NSSAI with service type information. In response to this, in 5GC 18, SMF and UPF are set for each service type information.

Next, a GPRS tunnel is formed between the set UPF and the gNB function equipped in the aerial vehicle 10-1 through 10-3. In this case, the route control device 26 of the 5GC 18 calculates or selects a route that satisfies the required QoS for each service type based on the service type included in the Requested NSSAI for the GPRS tunnel between the gNB and the UPF.

The QoS required by the service type 2 can be met by a route via link 3, link 4 and feeder link 3. Therefore, in this example of operation, such a route is selected for the GPRS tunnel with respect to the UE 14.

The route control device 26 assigns a unique TEID (Tunnel Endpoint Identifier) for each GPRS tunnel, and distributes a routing table to the satellite 22, 24 and the aerial vehicle 10 on the route. Table 10 shows an example of a routing table when traffic flows from UE 14 to 5GC 18. Here, TEID is assigned 1.

TABLE 10

| | | |
|---|---|---|
| Destination | TEID | Next Hop |

Routing table of aerial vehicle 10-1

| | | |
|---|---|---|
| 192.168.6.1 | 1 | 192.168.3.1 |
| | | (Aerial vehicle 10-2) |

Routing table of aerial vehicle 10-2

| | | |
|---|---|---|
| 192.168.6.1 | 1 | 192.168.4.1 |
| | | (Aerial vehicle 10-3) |

Routing table of aerial vehicle 10-3

| | | |
|---|---|---|
| 192.168.6.1 | 1 | 192.168.5.1 (Router 28) |

Routing table of Router 28

| | | |
|---|---|---|
| 192.168.6.1 | 1 | 192.168.6.1 |

After the distribution of the above table is complete, the satellite 22, 24, and the aerial vehicle 10 on the route issue commands for transmission control and band control that meet the required transmission rate for each session. Then, when a GPRS tunnel is stretched between the gNB and the UPF, the UE 14 initiates communication.

The traffic flowing from UE 14 to 5GC 18 includes TEID in addition to the IP address of the destination. Aerial vehicles 10, satellites 22, 24 and routers on the route refer to the TEID in addition to the destination IP address to flow traffic to the next hop. This makes it possible to transfer traffic on the route specified for each GPRS tunnel. Similarly, for traffic flowing from 5GC 18 to UE 14, a routing table for reverse route is distributed. This makes it possible to transfer traffic on the route specified for each GPRS tunnel.

As explained above, the wireless communication system of the present embodiment selects a route suitable for the GPRS tunnel according to the required QoS of the UE 14 in consideration of the band, propagation delay, and jitter of each link. Therefore, according to the system of the present embodiment, the required QoS of the UE 14 can be properly satisfied while utilizing the NTN and according to the 5G communication standard.

It should be noted that, in the third embodiment described above, the service type information is communicated to 5GC 18 using NSSAI. However, the present disclosure is not limited thereto. The information of the service type may be notified using, for example, 5QI (5G QoS Identifier), or ARP (Address Resolution Protocol).

### Fourth Embodiment

Next, a fourth embodiment of the present disclosure will be explained. The wireless communication system of the present embodiment can be realized by the configuration shown in FIG. 3 or FIG. 5, as in the cases of the first through third embodiments described above.

In the wireless communication system of the first to third embodiments, a communication path is selected every time the UE 14 establishes communication as described above. However, since the link band between the satellites 22, 24 and the aerial vehicle 10 is finite, if the sessions and tunnels are continued to be accommodated, the transmission speed to satisfy QoS cannot be provided. As a result, there may arise a case where a session or tunnel cannot be accommodated at the link between the satellite 22, 24 and the aerial vehicle 10.

Note that, with respect to the UE 14 of service type 2 illustrated in the first to third embodiments, as described above, the aerial vehicle route is suitable as a route that satisfies QoS. On the other hand, when the UE 14 is of a service type 1, the QoS can be satisfied in the above LEO route as well as in the aerial vehicle route. Therefore, for the UE 14 of service type 1, both the aerial vehicle route and the LEO route are candidates for the adopted route. In addition, when the UE 14 is of a service type 3, the QoS can be satisfied by the GEO route as well as the aerial vehicle route and the LEO route. Therefore, in that case, there are three candidate routes.

The wireless communication system of the present embodiment is characterized in that the route control device 26 sets a policy to change the route to be preferentially selected for each service type. Specifically, in the present embodiment, the following policies are set.

### [Service Type 1]

Preferentially select LEO route

### [Service Type 2]

Preferentially select aerial vehicle route

### [Service Type 3]

Preferentially select GEO route

In other words, when the UE 14 is of service type 3, all routes can be candidates for a session or tunnel. However, the GEO route cannot be a candidate when the UE 14 is of service type 1 or 2. Therefore, when UE 14 is of service type 3, the frequency of use of the LEO route and the aerial vehicle route will be reduced by selecting the GEO route as a priority. As a result, in the system of the present embodiment, the LEO route and the aerial vehicle route can be preferentially assigned to the application of service type 1 or 2, and the number of sessions or tunnels suitable for those service types can be increased.

### Fifth Embodiment

Next, a fifth embodiment of the present disclosure will be explained. The wireless communication system of the present embodiment can be realized by the configuration shown in FIG. 3 or FIG. 5, as in the cases of the first through fourth embodiments described above.

Priority may be set for each service type, regarding the accommodation of UE 14. The wireless communication system of the present embodiment is characterized in that the number of accommodation sessions and the allocated band according to the priority are set in advance for each service type in the link between the satellite 22, 24 and the aerial vehicle 10.

With the above features, in the present embodiment, a bandwidth for a session or a tunnel can be reserved for the UE 14 of the service type with a high priority. Then, when the number of communication of the service type with low priority increases, communication of such a type is limited. Therefore, according to the system of the present embodiment, it is possible to always accommodate a certain number of high-priority service type communications.

The system of the present embodiment further has a function to change the setting of the allocated bandwidth and the number of accommodated sessions for each service type according to the change in the network state. For example, in the case of a severe disaster, it is necessary to prioritize communication via smartphones over IoT communication. In other words, it is necessary to lower the priority of IoT communication and raise the priority of smartphone communication.

In such a case, the system of the present embodiment reduces the proportion of the allocated bandwidth and the number of accommodated sessions of the service type 3 (massive IoT services). As a result, the proportion of bandwidth and the number of accommodated sessions allocated to high-speed, large-capacity services for service type 1, that is, for smartphone communication, will increase. Therefore, according to the system of the present embodiment, it is possible to accommodate more communication by the smartphone than in normal times when a severe disaster occurs.

In the present embodiment, information such as the number of accommodation sessions according to the priority can be stored, for example, in a memory device equipped in the route control device 26. However, the present disclosure is not limited thereto, and the route control device 26 may obtain the above information from the memory device installed outside.

### Sixth Embodiment

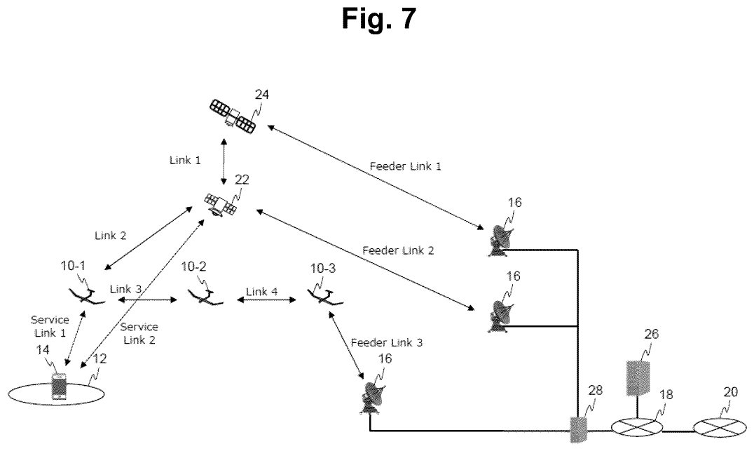

Next, a sixth embodiment of the present disclosure will be explained with reference to FIG. 7 along with FIGS. 3 and 5. The wireless communication system of the present embodiment can be realized by the configuration shown in FIG. 3 or FIG. 5, as in the cases of the first through fifth embodiments described above. However, in the present embodiment, the UE 14 shall have the function of connecting to a plurality of relay points composed of the LEO satellite 22, 24 and the aerial vehicle 10.

In the first embodiment of the present disclosure, a route for a session is selected between a single aerial vehicle 10 and the mobile core network 18, with the UE 14 connecting to the single aerial vehicle 10. In the present embodiment, since the UE 14 can be connected to a plurality of relay points composed of the satellite 22, 24 and the aerial vehicle 10 as described above, a plurality of candidate routes occur between the UE 14 and the satellite 22, 24 and the aerial vehicle 10.

FIG. 7 illustrates a configuration in which the UE 14 can connect to both the HAPS and LEO satellite networks. In this case, as candidate routes for connecting the UE 14 and the NTN, there is a service link 1 with the aerial vehicle 10-1 as the relay point, and a service link 2 with the LEO satellite 22 as the relay point. Further, the candidate routes using the service link 2 include two routes via the feeder link 2 and a route via the link 1 and the feeder link 1.

Hereinafter, an example of operation when the UE 14 uses service type 1, that is, a high-speed, large-capacity service, will be explained. The required QoS of Service Type 1 can be met by a aerial vehicle route and a LEO route. Therefore, in the present embodiment, the following three routes are assumed to be routes that satisfy QoS.
1. Aerial vehicle route via service link 1
2. LEO route via service link 1 and link 2
3. LEO route via service link 2

In the present embodiment, the route control device 26 selects one of the above three routes for the service type 1 session.

Should the UE 14 uses service type 2, i.e., ultra-reliable low-latency service, the only route that meets the required QoS is the aerial vehicle route. Therefore, in this case, a route via the service link 1, the link 3, the link 4 and the feeder link 3 is selected for the session.

When the route for the session is selected, handover control is executed for the service links 1 and 2. As a result, the connection to the predetermined aerial vehicle 10 or the LEO satellite 22 is maintained or switched. The route from the aerial vehicle 10 and the satellites 22, 24 to the mobile core network 18 can be set appropriately for the session by the same processing as in the case of the first embodiment.

### Seventh Embodiment

Next, a seventh embodiment of the present disclosure will be explained. The wireless communication system of the present embodiment can be realized by the configuration shown in FIG. 3 or FIG. 5 as in the case of the first to sixth embodiments.

In the first to sixth embodiments described above, the communication quality between the satellite 22, 24 and the aerial vehicle 10 varies due to the movement of the LEO satellite 22 and the aerial vehicle 10. In particular, LEO satellite 22 is moving against the aerial vehicles 10 of HAPS and GEO satellite 24. As a result, the distance of the link connecting the aerial vehicle 10 and the LEO satellite 22 and the distance of the link connecting the LEO satellite 22 and the GEO satellite 24 fluctuate over time. As a result, the propagation delay time at those links also fluctuates with time.

Further, since the attenuation of the radio wave varies according to the distance of the link, the reception gain of the satellite 22, 24 and the aerial vehicle 10 also varies with time. In addition, the angle between the aerial vehicle 10 or the GEO satellite 24 and the LEO satellite 22 also changes, and the reception gain of the antennas mounted on them also changes as a result of this change. Therefore, when a control (such as the adaptive modulation and coding scheme) is used to change a modulation method and/or coding rate in conjunction with the reception gain, the effective transmission rate varies according to the change in the reception gain.

On the other hand, the orbit of LEO satellite 22 is known in advance. Therefore, once the current position of the LEO satellite 22 and the aerial vehicle 10 is known, the future distance and angle between the LEO satellite 22 and the GEO satellite 24 and the future distance and angle between the LEO satellite 22 and the aerial vehicle 10 can be predicted by calculation.

Therefore, the wireless communication system of the present embodiment performs the following processing after predicting the distance and the angle of each link connecting the satellite 22, 24 and the aerial vehicle 10. Note that these processes are performed in the route control device 26. However, these processes may be executed by a device different from the route control device 26.

1. Based on the distance between the LEO satellite 22 and the GEO satellite 22, and the distance between the LEO satellite 22 and the aerial vehicle 10, the amount of variation in the propagation delay time at each link connecting them is calculated.

2. Based on the distance and angle between the LEO satellite 22 and the GEO satellite 22, and the distance and angle between the LEO satellite 22 and the aerial vehicle 10, the amount of loss of gain in each link connecting them is calculated. Furthermore, based on the result of the calculation, the fluctuation amount of the receiving gain in each of the LEO satellite 22, the GEO satellite 24, and the aerial vehicle 10 is calculated. Then, an amount of fluctuation in the effective transmission speed of each link is calculated based on the calculated reception gain.

3. Calculate the longest propagation delay time and the lowest effective transmission rate among the links included therein for each of the candidate routes based on the results of Step 1, and 2. The resulting longest propagation delay time and the lowest execution transmission rate shall be the propagation delay time and execution transmission rate of each candidate route.

4. Calculate or select a route that satisfies the required QoS of the UE 14 using the results of Step 3.

Note that, in the above example, it is assumed that only the LEO satellite 22 will move, but it may also be assumed that the flight object 10 included in the HAPS network will change in position. In that case, by using the flight path information of the aerial vehicle 10, the distance and angle of the link can be estimated using the same method as described above, and the result can be reflected in the route selection.

In addition, in the above example, the fluctuation situation is predicted in real time, and the result is reflected in route selection, but the present disclosure is not limited thereto. For example, a training period may be set before the operation of the system starts, and the fluctuation status of the communication quality may be observed in advance and stored in the memory device. In this case, when a connection request from the UE 14 is generated, the communication route may be determined using the information on the fluctuation situation stored in the memory device.

As explained above, according to the embodiment of the present disclosure, when the wireless terminal performs communication, it is possible to set a route in an End to End manner that satisfies the required QoS. Therefore, it is possible to cause the wireless terminal to execute various applications. In addition, in the 5th Generation mobile system, it will be possible to properly set a route of the GPRS tunnel between the wireless base station and the 5G core network so as to meet the required QoS of the wireless terminal.

Note that, in the first to seventh embodiments described above, the wireless communication system is based on the assumption that the NTN is used, but the present disclosure is not limited thereto. In other words, the communication path setting method according to the present disclosure can be widely applied when a network including a plurality of links with different bands and propagation delays is used.

### REFERENCE SIGNS LIST

10, 10-1 to 10-3 Aerial vehicle
12 Service area
14 Wireless device (UE)
16 Ground Base Station
18 Mobile Core Network, 5GC
20 Data Network
22 LEO Satellite
24 GEO Satellite
26 Route control device
28 Router

1. A wireless communication system in which a plurality of communication stations configure a network for transferring packets by mutually establishing links, the plurality of communication stations including a connection communication station for providing a service area to a wireless terminal, and the wireless terminal connecting to the connection communication station and transmitting and receiving packets to and from a data network, the wireless communication system comprising a control station configured to perform:
collecting information on required QoS corresponding to a service type of the wireless terminal;
predicting communication quality in a link between the plurality of communication stations;
determining a communication path based on the communication quality so that the required QoS is satisfied between the connection communication station and the data network; and
distributing a routing table including transfer destination information of traffic to at least a communication station included in the communication path, wherein
said communication station included in the communication path is configured to transfer a packet between the wireless terminal and the data network in accordance with the routing table.

2. The wireless communication system according to claim 1, wherein
said control station is configured to further execute notifying the communication station of bandwidth information to be guaranteed when bandwidth guarantee is necessary to satisfy the required QoS, and
said communication station is configured to perform satisfying the bandwidth guarantee based on the bandwidth information.

3. The wireless communication system according to claim 1, wherein
said plurality of communication stations include a non-terrestrial mobile communication station configured by a satellite or an unmanned aerial vehicle, and
said predicting communication quality includes:
acquiring movement information of the non-terrestrial mobile communication station; and
predicting the communication quality based on the movement information.

4. The wireless communication system according to claim 1, wherein
said plurality of communication stations include a non-terrestrial mobile communication station configured by a satellite or an unmanned aerial vehicle, and
said communication system comprising a memory that stores a variation status of the communication quality measured during a training period before system operation, and wherein
said predicting communication quality includes:
reading the variation status from the memory; and
predicting the communication quality based on the information read in said reading.

5. The wireless communication system according to claim 1, wherein
said plurality of communication stations include 5G base stations supporting a fifth-generation communication standard,
said data network includes a 5G core network supporting the fifth-generation communication standard,
said wireless terminal is configured to support the fifth-generation communication standard,
said determining a communication path includes determining a path of a GPRS tunnel between the connection communication station and the 5G core network based on the communication quality so that the required QoS information is satisfied,
said routing table includes information of TEID together with the transfer destination information, and
said communication stations included in the communication path are configured to transfer packets between the wireless terminals and the 5G core network based on the transfer destination information and the TEID by using the 5G base stations.

6. The wireless communication system according to claim 1, wherein said collecting information on required QoS includes processing for deriving the information of the required QoS based on any one of NSSAI, 5QI, and ARP.

7. The wireless communication system according to claim 1, wherein said determining a communication path includes determining the communication path based on at least one of a transmission rate, an available band, a propagation delay time, a link connection time, a disconnection frequency, and stability in a link between the plurality of communication stations.

8. The wireless communication system according to claim 1, wherein
said determining a communication path includes:
collecting information on unused excess bandwidth for each of links between the plurality of communication stations;
determining the communication path such that a used bandwidth does not exceed the excess bandwidth in all the links.

9. The wireless communication system according to claim 1, wherein
said service type includes a plurality of types having different required QoS, and
said determining a communication path includes:
acquiring information on a priority communication path defined for each service type; and
determining the communication path based on the information on the priority communication path, wherein
said priority communication path is set to a communication path having the lowest use frequency in other service types for a service type in which a plurality of communication paths can be used.

10. The wireless communication system according to claim 1, comprising a database that stores records of communication paths determined in the past, wherein
said determining a communication path includes:
reading, when selecting a communication path of a wireless terminal to be newly connected, a communication path assigned to a required QoS similar to a required QoS of this wireless terminal from the database; and
determining the communication path by referring to the path read in this reading.

11. The wireless communication system according to claim 1, wherein
said service type includes a plurality of types having different required QoS,
said wireless communication system comprises a memory device that stores, for each required QoS, at least one information on an allocation ratio of a band in a link between the communication stations and the number of accommodated sessions or the number of tunnels, and
said determining a communication path includes determining the communication path under the restriction indicated by said at least one information.

12. The wireless communication system according to claim 11, wherein
said determining a communication path includes:
acquiring a priority of the required QoS; and
setting said at least one information according to the priority.

13. A communication path control device that controls communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control device is configured to perform:
collecting information on required QoS corresponding to a service type of the wireless terminal;
predicting communication quality in a link between the plurality of communication stations;
determining a communication path based on the communication quality so that the required QoS is satisfied between the connection communication station and the data network; and
distributing a routing table including transfer destination information of traffic to at least a communication station included in the communication path.

14. A communication path control method for controlling communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control method including:
collecting information on required QoS corresponding to a service type of the wireless terminal;
predicting communication quality in a link between the plurality of communication stations;
determining a communication path based on the communication quality so that the required QoS is satisfied between the connection communication station and the data network; and
distributing a routing table including transfer destination information of traffic to at least a communication station included in the communication path.

15. A computer-readable recording medium recording a communication path control program for controlling communication paths which are used by a wireless terminal connecting to a connection communication station and transmitting and receiving packets to and from a data network in a system in which a plurality of communication stations configure a network for transferring packets by mutually establishing links, the plurality of communication stations including said connection communication station for providing a service area to said wireless terminal, the communication path control program includes a program that causes a processor to execute:
collecting information on required QoS corresponding to a service type of the wireless terminal;
predicting communication quality in a link between the plurality of communication stations;
determining a communication path based on the communication quality so that the required QoS is satisfied between the connection communication station and the data network; and
distributing a routing table including transfer destination information of traffic to at least a communication station included in the communication path.
